(19) United States
(12) Patent Application Publication
(10) Pub. No.: US 2024/0111367 A1
(43) Pub. Date: Apr. 4, 2024

(54) AN INTERACTION SYSTEM

(71) Applicant: Flatfrog Laboratories AB, Lund (SE)

(72) Inventors: Ola Wassvik, Lammhult (SE); Håkan Bergström, Torna-Hällestad (SE); Aleksander Kocovski, Malmö (SE)

(21) Appl. No.: 18/263,681

(22) PCT Filed: Feb. 9, 2022
(86) PCT No.: PCT/SE2022/050139

§ 371 Date: Jul. 31, 2023

(30) Foreign Application Priority Data
Feb. 9, 2021 (SE) 2130041-3

(51) Int. Cl. G06F 3/01; G06F 3/042; G06V 40/20

(52) U.S. Cl. CPC G06F 3/017; G06F 3/0421; G06V 40/28; G06F 2203/04101

(57) ABSTRACT

An interaction system for receiving gesture input from an object is disclosed comprising a panel having a surface and a perimeter, the surface extending in a plane having a normal axis, a sensor configured to detect incident light from the object, a processor in communication with the sensor and being configured to determine a position of the object relative the surface based on the incident light, when the object is at a distance from the surface along the normal axis, determine the gesture input based on said position, and output a control signal to control the interaction system based on the gesture input.

### TECHNICAL FIELD

The present invention relates to an interaction system for receiving gesture input from an object and a related method.

### BACKGROUND ART

To an increasing extent, interaction systems, such as touch-sensing apparatuses, are being used in presentation- and conference systems. A presenter may interact with a touch sensing display in various ways, such as by manipulating different graphical user interface (GUI) elements or display objects located at different parts of the touch display, or highlighting parts of a presentation, besides from the typical writing and drawing of text and figures on the display.

In one category of touch-sensitive apparatuses a set of optical emitters are arranged around the perimeter of a touch surface of a panel to emit light that is reflected to propagate across the touch surface. A set of light detectors are also arranged around the perimeter of the touch surface to receive light from the set of emitters from the touch surface. I.e., a grid of intersecting light paths is created across the touch surface, also referred to as scanlines. An object that touches the touch surface will attenuate the light on one or more scanlines of the light and cause a change in the light received by one or more of the detectors. The coordinates, shape or area of the object may be determined by analysing the received light at the detectors. In one category of touch-sensitive apparatuses the light is reflected to propagate above the touch surface, i.e., the intersecting light paths extend across the panel above the touch surface.

When several types of interaction, as exemplified above, occur repeatedly over different portions of the display screen, and when the display may be densely populated with different graphical objects or text, it may be challenging for the presenter to attain a desired level of control precision and an efficient workflow. While other types of input abilities of such interaction system may be necessary to increase the level of control, it is also desirable to maintain an intuitive user experience and to keep system costs at a minimum and in some examples facilitate such enhancement without, or with a minimum of, hardware upgrades. Previous techniques may thus lack intuitive user input capabilities to facilitate the interaction with complex GUI's, and/or may require incorporating complex and expensive opto-mechanical modifications to the interaction system for enhancing user input.

### SUMMARY

An objective is to at least partly overcome one or more of the above identified limitations of the prior art.

One objective is to provide an interaction system which provides for facilitated user interaction, while keeping the cost of the interaction system at a minimum.

One or more of these objectives, and other objectives that may appear from the description below, are at least partly achieved by means of interaction systems according to the independent claims, embodiments thereof being defined by the dependent claims.

According to a first aspect an interaction system for receiving gesture input from an object is provided comprising a panel having a surface and a perimeter, the surface extending in a plane having a normal axis, a sensor configured to detect incident light from the object, a processor in communication with the sensor and being configured to determine a position (P) of the object relative the surface based on the incident light, when the object is at a distance from the surface along the normal axis, determine the gesture input based on said position, and output a control signal to control the interaction system based on the gesture input.

According to a second aspect a method is provided for receiving gesture input from an object in an interaction system comprising a panel, the method comprising detecting incident light from the object, determining a position (P) of the object relative a surface of the panel based on the incident light, when the object is at a distance from the surface along a normal axis of the surface, determining the gesture input based on said position, and outputting a control signal to control the interaction system based on the gesture input.

According to a third aspect a computer program product is provided comprising instructions which, when the program is executed by a computer, cause the computer to carry out the steps of the method according to the second aspect.

Further examples of the invention are defined in the dependent claims, wherein features for the first aspect may be implemented for the second aspect, and vice versa.

Some examples of the disclosure provide for an interaction system with a facilitated user input.

Some examples of the disclosure provide for an interaction system with an improved user experience.

Some examples of the disclosure provide for an interaction system that is less costly to manufacture.

Some examples of the disclosure provide for an interaction system that is easier to manufacture.

Still other objectives, features, aspects, and advantages of the present disclosure will appear from the following detailed description, from the attached claims as well as from the drawings.

It should be emphasized that the term “comprises/comprising” when used in this specification is taken to specify the presence of stated features, integers, steps, or components but does not preclude the presence or addition of one or more other features, integers, steps, components, or groups thereof.

### BRIEF DESCRIPTION OF DRAWINGS

These and other aspects, features and advantages of which examples of the invention are capable of will be apparent and elucidated from the following description of examples of the present invention, reference being made to the accompanying drawings, in which;

FIG. 1a is a schematic illustration, in a top-down view, of the interaction system, and a gesturing object above a panel thereof, according to one example;

FIG. 1b is a schematic illustration, in a cross-sectional view, of the interaction system, and a gesturing object above a panel thereof, according to one example;

FIG. 2a is a schematic illustration, in a cross-sectional view, of the interaction system comprising a touch-sensing apparatus, according to one example;

FIG. 2b is a schematic illustration, in a top-down view, of the interaction system comprising a touch-sensing apparatus, according to one example;

FIG. 3a is a schematic illustration, in a top-down view, of the interaction system, and a gesturing object above a panel thereof, according to one example;

FIG. 3b is a schematic illustration, in a cross-sectional view, of the interaction system, and a gesturing object above a panel thereof, according to one example;

FIGS. 4a-d are schematic illustrations, in top-down views, of the interaction system, according to examples of the disclosure;

FIGS. 5a-b are schematic illustrations, in cross-sectional side views, of the interaction system, according to examples of the disclosure;

FIG. 6a is a schematic illustration, in a cross-sectional view, of the interaction system, according to one example;

FIG. 6b is a schematic illustration, in a top-down view, of the interaction system, according to one example;

FIGS. 7a-c are schematic illustrations, in cross-sectional side views, of the interaction system, according to examples of the disclosure;

FIGS. 8a-b are schematic illustrations, in cross-sectional side views, of a detail of the interaction system, according to examples of the disclosure;

FIGS. 9a-b are schematic illustrations, in cross-sectional side views, of a detail of the interaction system, according to examples of the disclosure;

FIG. 10a is a schematic illustration, in a top-down view, of the interaction system, according to one example;

FIG. 10b is a schematic illustration, in a cross-sectional view, of the interaction system, according to one example;

FIG. 10c is a schematic illustration, in a perspective view, of a detail of the interaction system, according to one example;

FIG. 10d is a schematic illustration, in a top-down view, of the interaction system, according to one example;

FIGS. 11a-c are schematic illustrations, in cross-sectional side views, of the interaction system, according to examples of the disclosure;

FIG. 12 is a schematic illustration, in a cross-sectional side view, of the interaction system, according to one example;

FIG. 13 is a schematic illustration, in a top-down view, of a detail of the interaction system, according to one example;

FIG. 14 is a schematic illustration, in a cross-sectional side view, of the interaction system, according to one example;

FIG. 15 is a schematic illustration, in a cross-sectional side view, of the interaction system, according to one example;

FIG. 16 is a schematic illustration, in a cross-sectional perspective view, of a detail of the interaction system, according to one example;

FIG. 17 is a schematic illustration, in a cross-sectional side view, of a detail of the interaction system, according to one example;

FIG. 18 is a schematic illustration, in a cross-sectional perspective view, of a detail of the interaction system, according to one example;

FIG. 19 is a schematic illustration, in a perspective view, of a detail of the interaction system, according to one example;

FIG. 20 is a schematic illustration, in a top-down view, of a detail of the interaction system, according to one example;

FIG. 21 is a flowchart of a method of for receiving gesture input from an object in an interaction system, according to one example; and

FIG. 22 is a schematic illustration, in a cross-sectional perspective view, of a detail of the interaction system, according to one example;

FIG. 23 is a schematic illustration, in a cross-sectional side view, of the interaction system, according to one example;

FIG. 24a is a schematic illustration, in a cross-sectional side view, of the interaction system, according to one example; and

FIG. 24b is a schematic illustration, in a top-down view, of a detail of the interaction system, according to one example.

### DETAILED DESCRIPTION OF EXAMPLE EMBODIMENTS

In the following, embodiments of the present invention will be presented for a specific example of an interaction system. Throughout the description, the same reference numerals are used to identify corresponding elements.

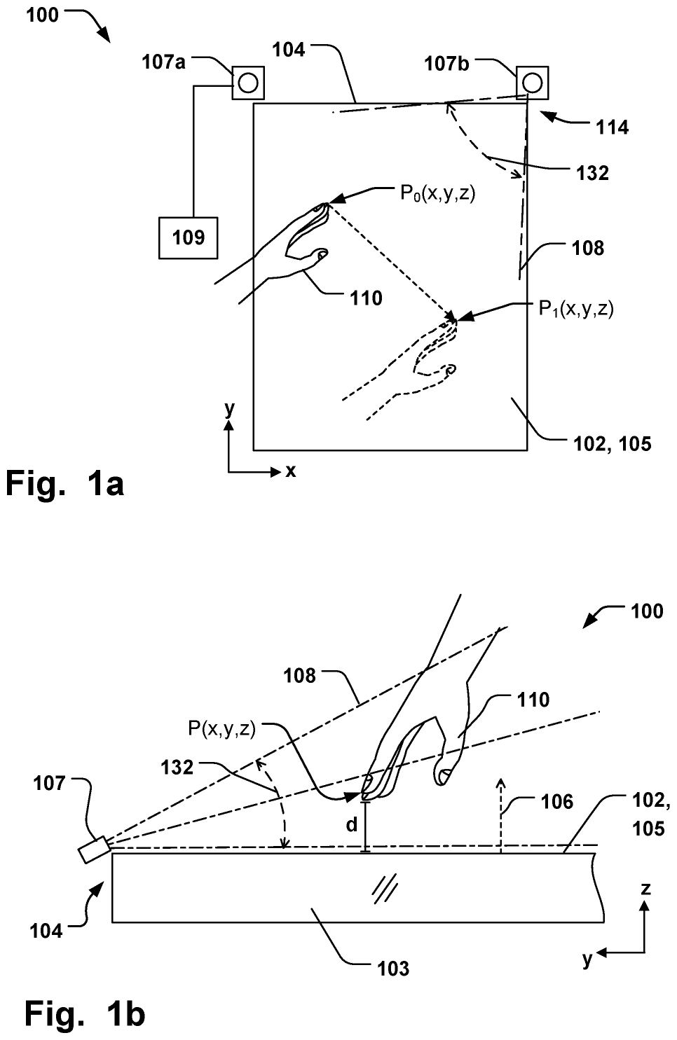

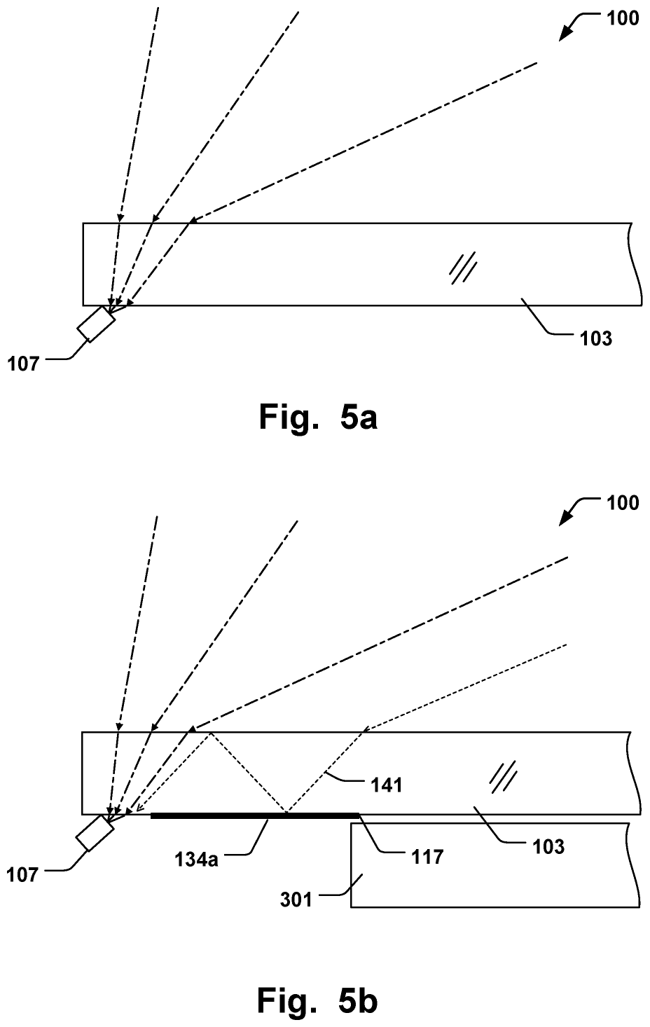

FIGS. 1a-b are schematic illustrations of an interaction system 100 for receiving gesture input from an object 110, in a top-down view and in a cross-sectional side view, respectively. The interaction system 100 comprises a panel 103 having a surface 102 and an outer perimeter 104. The surface 102 extends in a plane 105 having a normal axis 106. The panel 103 may be made of any solid material (or combination of materials) such as glass, poly(methyl methacrylate) (PMMA) and polycarbonates (PC). The panel 103 may be designed to be overlaid on or integrated into a display device 301, as schematically illustrated in the examples of FIGS. 5b, 17, and 18.

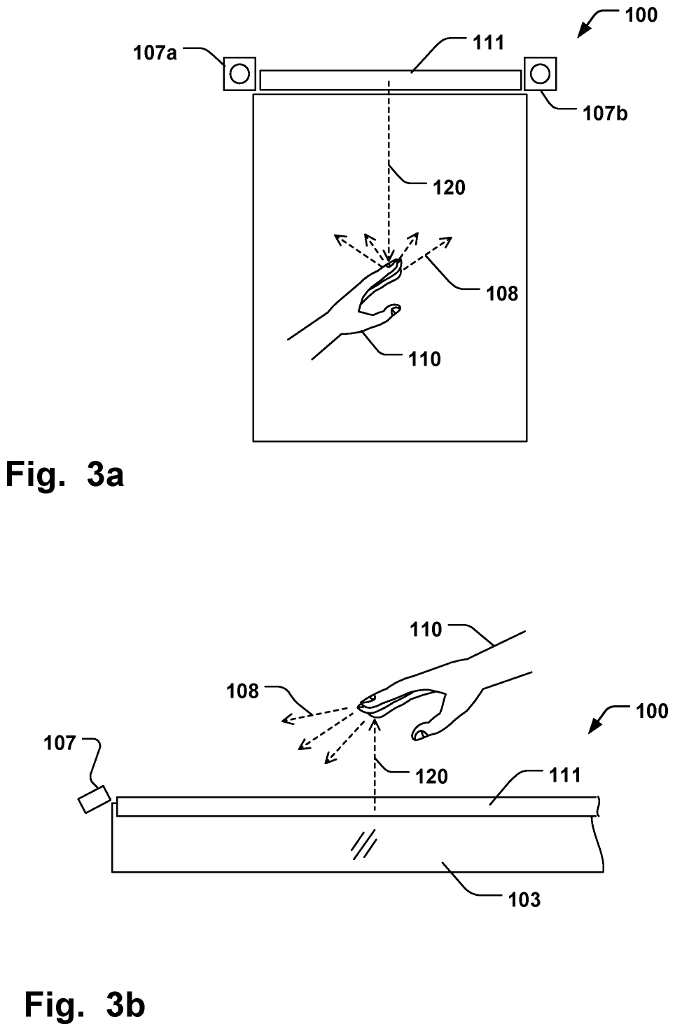

The interaction system 100 comprises a sensor 107, 107a, 107b, configured to detect incident light 108 from the object 110. The sensor 107, 107a, 107b, may receive incident light 108 across a field of view 132 of the sensor 107, 107a, 107b, as exemplified in FIGS. 1a-b. The interaction system 100 may comprise any plurality of sensors 107, 107a, 107b, as exemplified in FIGS. 1-20. In one example the interaction system 100 comprises a single sensor 107. The sensor 107 or sensors 107a, 107b, are referred to as sensor 107 in examples below for brevity. The incident light 108 may be light scattered by the object 110 towards the sensor 107, and/or emitted by the object 110 as black body radiation. The sensor 107 may be configured to detect visible and/or infrared light as discussed further below. The object 110 may scatter ambient light, such as artificial room light or sunlight, and/or illumination light 120 directed onto the object 110 by an illuminator 111, as schematically shown in e.g. FIGS. 3a-b and described in more detail below.

The interaction system 100 comprises a processor 109 in communication with the sensor 107. The processor 109 is configured to determine a position (P) of the object 110 relative the surface 102 based on the incident light 108, when the object 110 is at a distance (d) from the surface 102 along the normal axis 106. FIG. 1b shows an example where the object 110, a user's hand, is at a distance (d) from the surface 102. The field of view 132 of the sensor 107 extends above the distance (d) in the direction of the normal axis 106, along the z-axis, and spans the area of the surface 102, in the x-y plane. The sensor 107 may thus capture image data of the object 110 when capturing the light 108 in the field of view 132. The processor 109 is configured to determine the position (P) based on the image data in the x-y coordinate system of the surface 102 and along the z-axis, being parallel with the normal axis 106. It is conceivable that in one example the position (P) is determined in the x-y plane only. In another example the position (P) may be determined along the z-axis only, e.g., for detecting the user's presence.

The processor 109 is configured to determine the user's gesture input based on the determined position (P) and output a control signal to control the interaction system 100 based on the gesture input. For example, the position (P) may be determined with respect to the surface 102 x-y coordinates for outputting a control signal to display visual representation of the gesture input at the determined x-y coordinate of the surface 102. The gesture input may result from a detected variation in the position (P), e.g., as the object 110 moves from position P₀ to P₁ in FIG. 1a. The control signal may thus be output to a display device 301, which may be arranged opposite a rear side 117 of the panel 103. The user may accordingly create visual content in a touch-free manner, while hovering or gesturing with the object 110 above the surface 102. The object 110 may be a user's hand, a stylus or other object the user utilizes to interact with the interaction system 100. In another example the control signal is input of a gesture command in a graphical user interface (GUI). The GUI may have numerous graphical interaction elements at defined x-y coordinates of the surface 102. As the user positions the object 110 over a selected GUI element, and the x-y coordinate of the position (P) is determined, a gesture input is detected at the associated x-y position of the GUI element allowing for touch-free input to the GUI.

In another example the position (P) is determined along the z-axis to add layers of control abilities to the GUI which previously has been limited to touch-based interaction. For example, positioning and gesturing the object 110 at a distance (d) from the surface 102 may input a different set of control signals to the interaction system 100 compared to generating touch input in contact with the surface 102. For example, a user may access a different set of GUI controls by gesturing at a distance (d) from the surface 102, such as swiping display screens of different content, erasing on virtual whiteboards etc., while providing touch input creates a different control response. In another example further layers of control abilities may be added in dependence on e.g., the detected z-coordinate of the object's position (P). E.g., swiping or toggling between different display screens may be registered as input at a first height above the surface 102, or detection of a user's presence to adapt the GUI accordingly, while touch-free interaction at a second height closer to the surface 102 activates a finer level of control of different GUI elements. The GUI may display a visual indication representing the user's current control layer.

The interaction system 100 thus provides for a facilitated and intuitive user interaction while providing for an increased level of control precision and efficient workflow, such as in complex GUI's.

The interaction system 100 may send control signals over a network for manipulation of visual content on remotely connected displays. Manipulation of visual content should be construed as encompassing any manipulation of information conveyed via a display, such as manipulation of graphical user interfaces (GUI's) or inputting of commands in GUI's via gesturing for further processing locally and/or over a network.

In some examples the position (P) may be utilized to adapt a GUI depending on e.g., which side of the panel 103 a user is located, e.g., on the right or left side of the panel 103. For example, the position of the user's waist along a bottom side of the panel 103 may be detected and the GUI may be adapted accordingly, such having GUI menus following the user's position, who accordingly do not need to reach across the panel 103 in order to access the menus. The GUI may in some examples be adapted to display input options if sensing an approaching user, e.g., showing input display fields just if presence is detected.

Alternatively, or in addition to controlling a GUI as discussed, it should be understood that the input may be utilized to control other aspects of the interaction system 100. For example, different gestures may be associated with input commands to control the operation of the interaction system 100, such as waking the interaction system 100 from a sleep mode, i.e., having the function of a proximity sensor, control of display brightness, or control of auxiliary equipment such as speaker sound level, muting of microphone etc. Proximity sensing may be based on detecting only the presence of an object 110, e.g., when waking from sleep mode.

The interaction system 100, or the sensor 107 and processor 109 thereof, may be configured to determine the position (P) in real-time with a frequency suitable to track the position (P) and consequently speed and acceleration of the gesturing object 110 along the x-, y-, z-coordinates. A speed and/or acceleration of the object 110 may be determined based on a plurality of determined positions (P_{0,} P₁) across the panel 103. The position (P), and in some examples the associated speed or acceleration, of the object 110 may be interpreted as an input of control signals uniquely associated with the different gestures of the object 110 across the panel 103. For example, if a user moves the hand 110 from P₀ to P₁, in FIG. 1a, the speed of the movement may trigger different input commands. E.g., a quicker movement may be associated with a scrolling input command, to scroll through different display content such as menus, presentation slides, document etc., whereas a slower movement may be associated with the highlighting of display content, e.g., by moving a presentation marker over presentation slides, text in documents etc.

The interaction system 100 may be configured to determine a size and/or geometry of the object 110 based on a plurality of determined positions (P_{0,} P₁) across the panel 103, and to determine the gesture input based on the size and/or geometry. Although the example of FIG. 1a shows different positions (P_{0,} P₁) of a part of the object 110 as a result of a movement of the object 110 across the panel 103, a plurality of determined positions (P_{0,} P₁) should also be construed as the positions defining the object's 110 outline in the x-y-z space, regardless if the object 110 moves or not. The positions (P_{0,} P₁) and size/shape of the object may be reconstructed from image data of the object 110 captured by the sensor 107. The resulting output may be adapted accordingly, e.g., a dimension of a presentation marker, such as a highlighting bar. E.g., hovering a finger above the surface 102 may produce a narrow highlighting line in the vertical direction while changing to hovering a palm above the surface 102 produces a wider bar in the vertical direction. Thus, the gesture input may be dependent on the size and/or geometry of the object 110. The gesture input may also be adapted depending on if a hand or a stylus is detected. E.g., the GUI may show larger interaction elements if a palm is detected, and correspondingly smaller objects if a stylus is detected.

Different examples of the interaction system 100 will be described with reference to FIGS. 1-24.

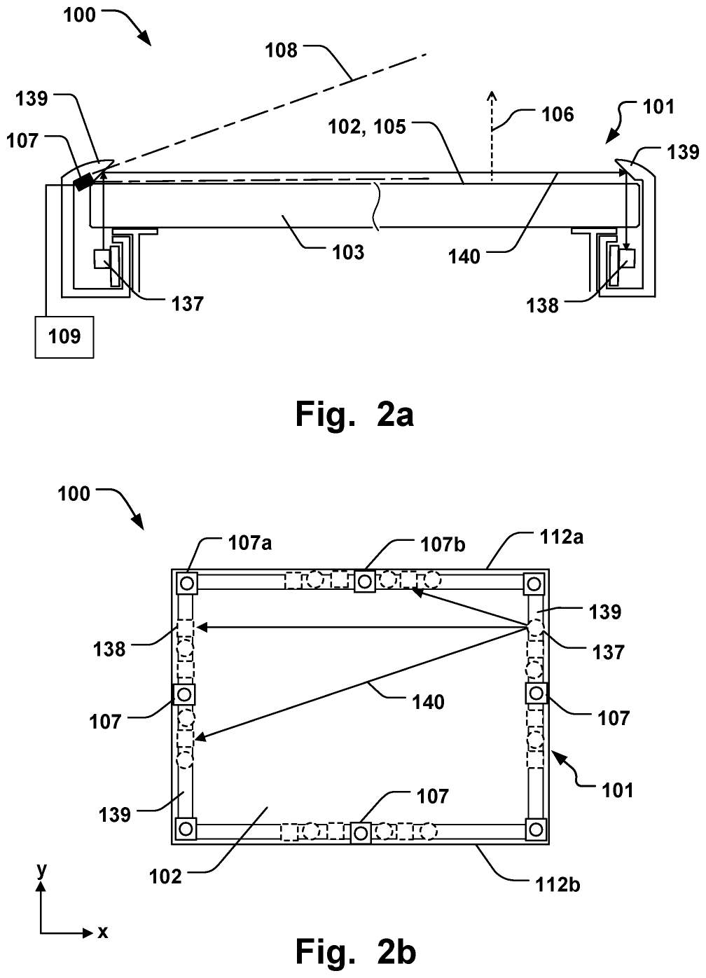

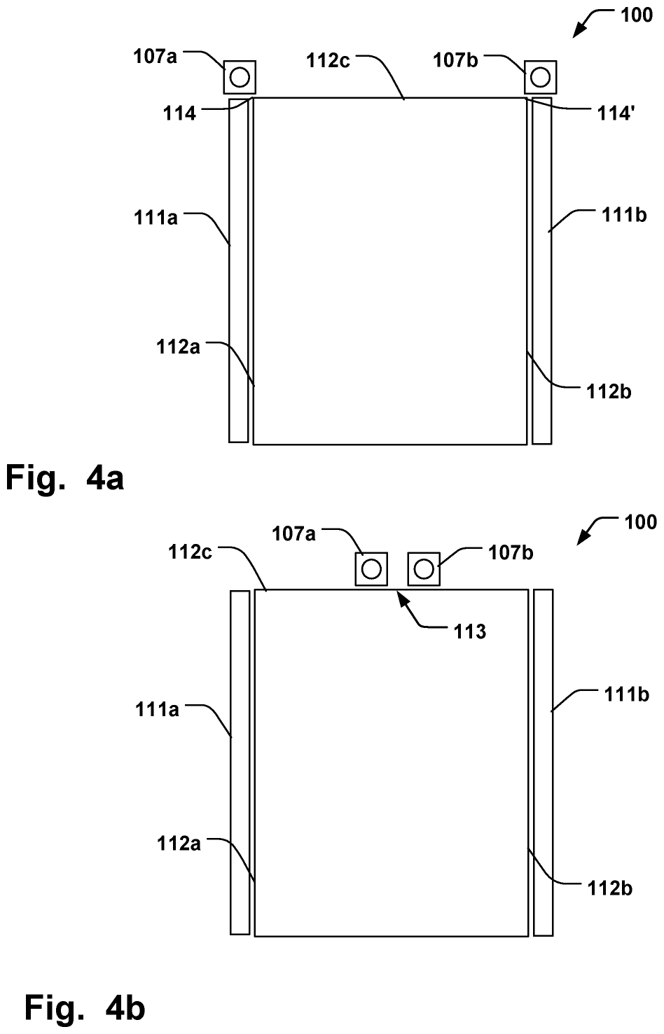

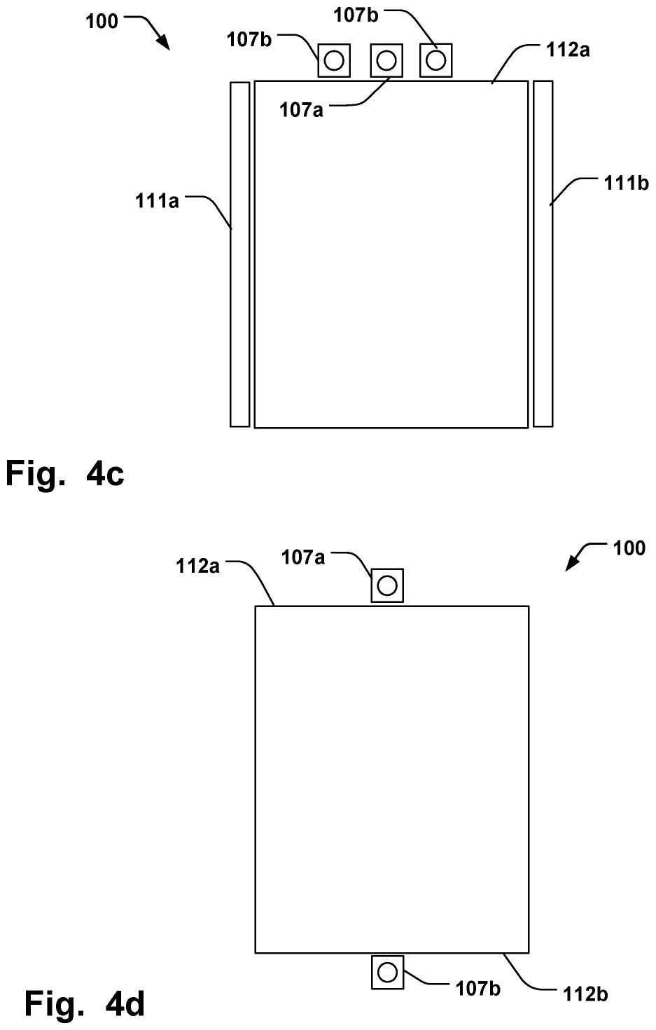

The sensor 107 may comprise a plurality of sensors 107a, 107b, arranged along the perimeter 104, as exemplified in e.g., FIG. 2b, 4a-c. Increasing the number of sensors 107 may provide for increasing the accuracy in determining the position (P) of the object 110. E.g., image data may be combined from the plurality of sensors 107 to determine the position (P) of the object 110 in the x-y-z directions. Image data from at least a first sensor 107a and a second sensor 107b arranged with a suitable angular separation with respect to the current object 110 may be utilized in a triangulation algorithm to determine the position of the object 110. A plurality of sensors 107 may allow for accurately determining the position (P) of the object 110 even in case of occluding the view of some of the sensors 107. A detection redundancy may thus be provided. A plurality of sensors 107a, 107b, may be arranged along a side 112a of the panel 103 to provide more accurate information of the object's 110 position (P) and movements in the x-y-z directions, as illustrated in the example of FIG. 4c. In one example, however, information of the object's 110 position in the x-y-z directions may be provided by a time-of-flight (TOF) sensor 107, such as a sensor 107 comprising a LIDAR. A TOF sensor 107 may thus provide for a more flexible positioning around the perimeter 104, such as having a pair of TOF sensors 107 at opposite sides 112a, 112b, of the panel 103 (FIG. 4d). It is also conceivable that in one example a single TOF sensor 107 provides for accurately determining the position (P) of the object 110.

In a further example the accuracy of determining the object's 110 position in x-y-z is increased by a light source 111, 111a, 111b, configured to scan light across the panel 103 and the object 110. In such case, a single sensor 107 may be sufficient to accurately determine the position (P) of the object 110.

The panel 103 may be arranged in a vertical plane in some applications, e.g., when mounted to a wall. The sensor 107 may in such application be arranged along a side 112a which corresponds to the upper side of the panel (e.g., FIG. 4c) and point vertically downwards to avoid ambient stray light.

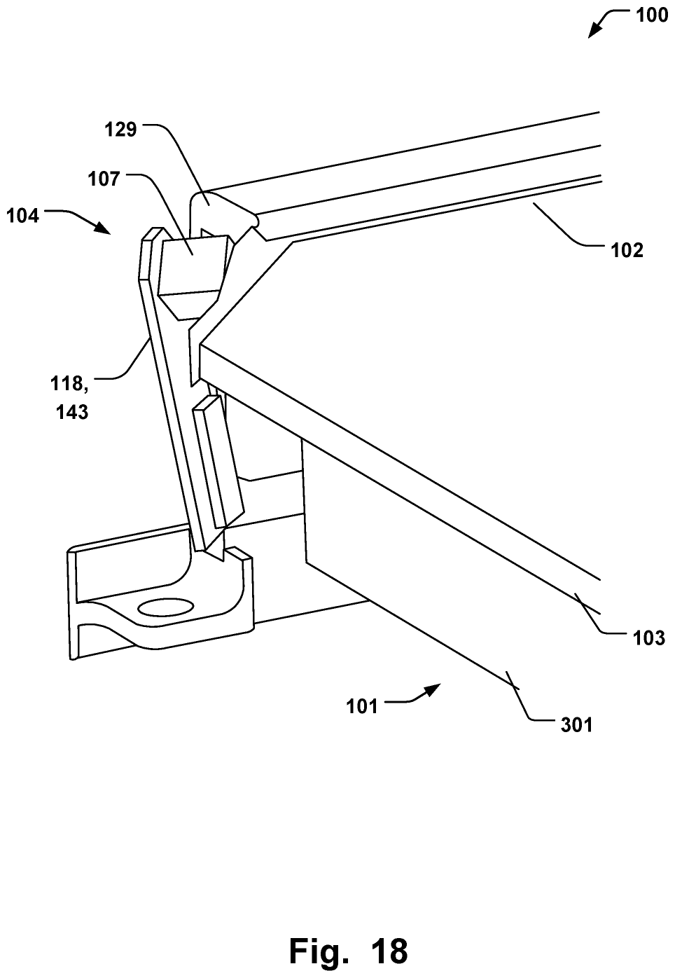

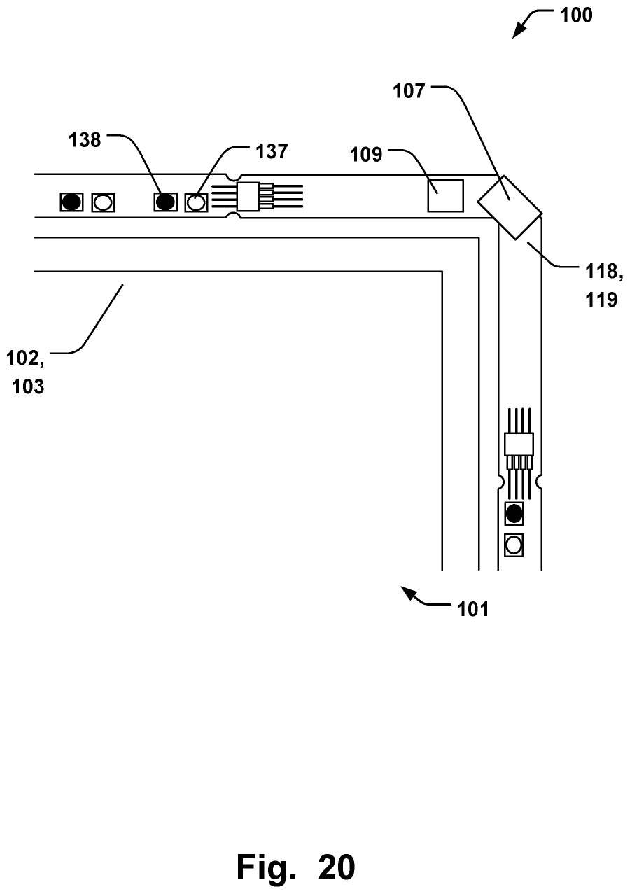

The sensors 107, 107a, 107b, may be arranged at corners 114 of the panel 103, as schematically illustrated in e.g., FIGS. 1a, 2b, 16, 18, 20. This may provide for an advantageous mechanical integration with the interaction system 100, e.g., if the interaction system 100 comprises a touch-sensing apparatus 101. For example, the space along the sides 112a, 112b, 112c, of the panel 103 may be optimized to accommodate emitters 137 and detectors 138 of such touch-sensing apparatus 101, while the corners 114 may be dedicated to accommodating the sensors 107. The amount of available space around and inside the frame element 129 of the interaction system 100 may thus be more effectively utilized, see e.g., FIGS. 18 and 20. Further, increasing the separation between sensors 107a, 107b, along a side 112c of the panel 103, as illustrated in e.g., FIG. 4a, provides in some examples for obtaining more accurate information of the object's 110 position (P). Thus, in one example sensors 107a, 107b, may be arranged at corners 114, 114′, of the panel 103 at opposite ends of a side 112c.

The sensor 107 may comprise an IR camera, a near IR camera, and/or a visible light camera, and/or a time-of-flight camera, and/or a thermal camera. Thus, the sensor 107 may comprise an image sensor for visible light or IR light, scattered by the object 110 towards the sensor 107. The sensor 107 may comprise a thermal sensor for IR black body radiation emitted by the object 110. The sensor 107 may be configured to detect other electromagnetic radiation, e.g., a sensor 107 for radar detection. The sensor 107 may comprise any combination of the aforementioned cameras and sensors.

Different examples of the position of the sensor 107 in the direction of the normal axis 106 are described below, as well as examples of sensor alignment and mounting.

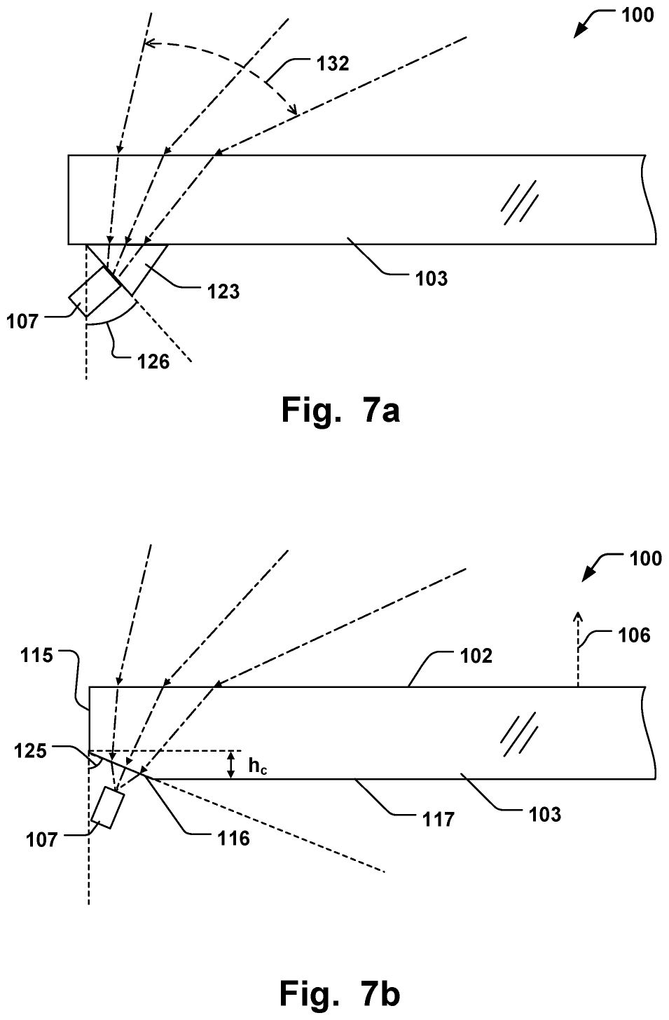

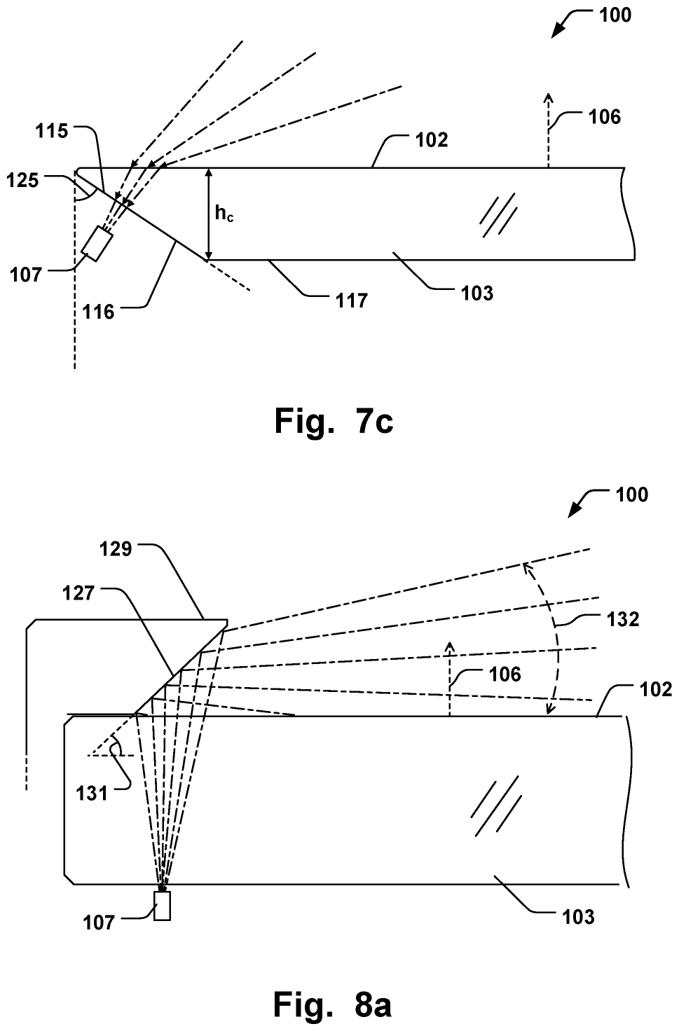

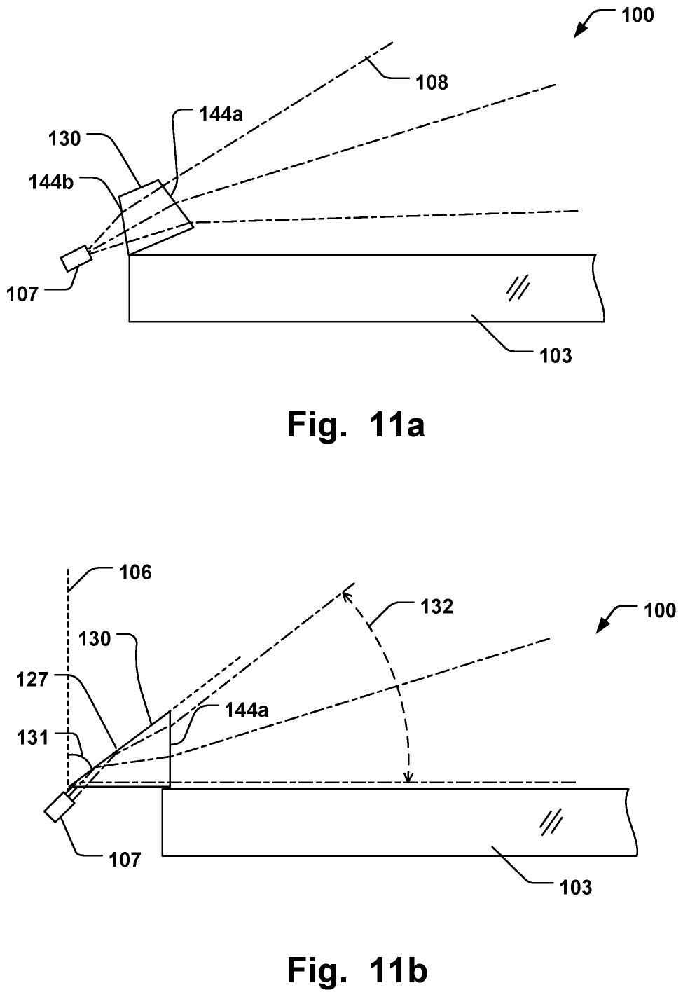

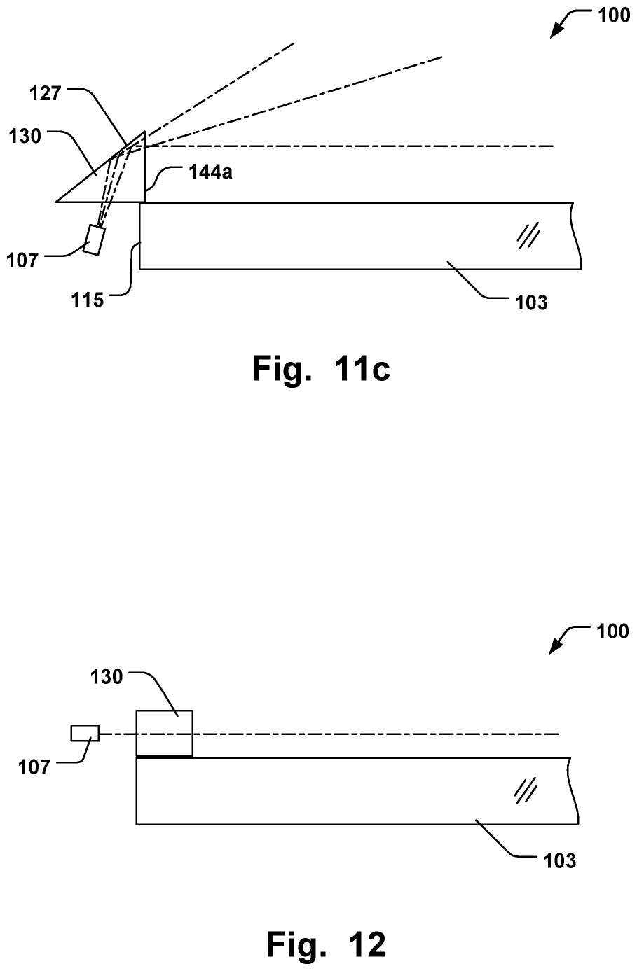

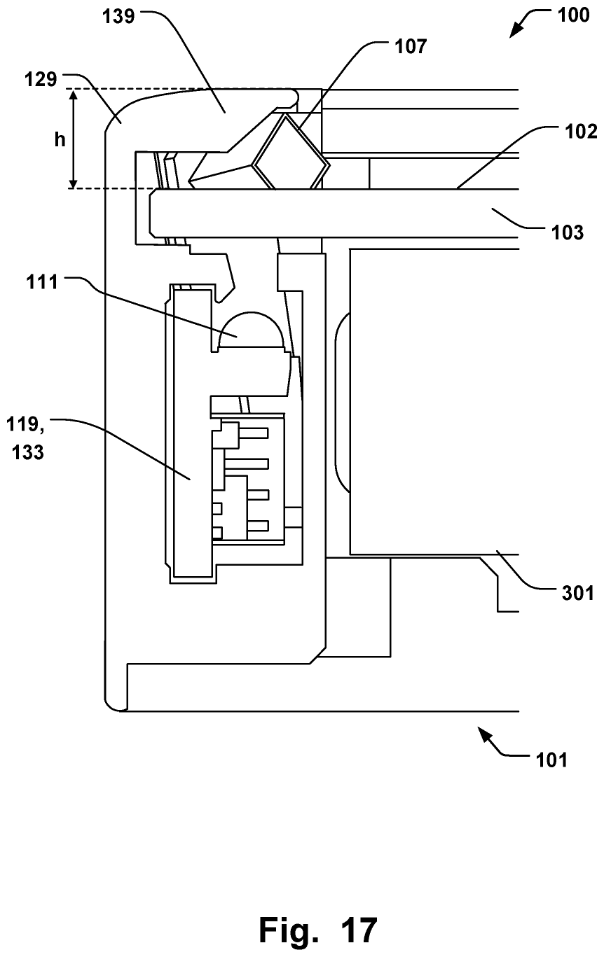

The sensor 107 may be arranged at least partly below the surface 102 in the direction of the normal axis 106, as schematically illustrated in e.g., FIGS. 1b, 11a-c, 16 and 17. This provides for reducing the bezel height (h), i.e., the portion of the frame element 129 extending above the surface 102 in the direction of the normal axis 106, as illustrated in FIG. 17. In one example the bezel height (h) is less than 4 mm. In another example the sensor 107 is sized to be accommodated in a bezel height of 2 mm for a particularly compact arrangement. In a further example, the panel 103 may be mounted to a support (not shown) which is flush with the surface 102. The sensor 107 may in such be mounted below the panel 103, e.g., as schematically illustrated in FIG. 7a. The bezel height (h) may be zero in such case.

In some examples the sensor 107 is arranged below, or at least partly below, the surface 102 while a prism 130 is arranged to couple light to the sensor 107 for an optimized field of view 132 while maintaining a compact bezel height (h), as exemplified in FIGS. 11a-c. The sensor 107 may in some examples however be arranged above the surface 102, as schematically illustrated in FIG. 12.

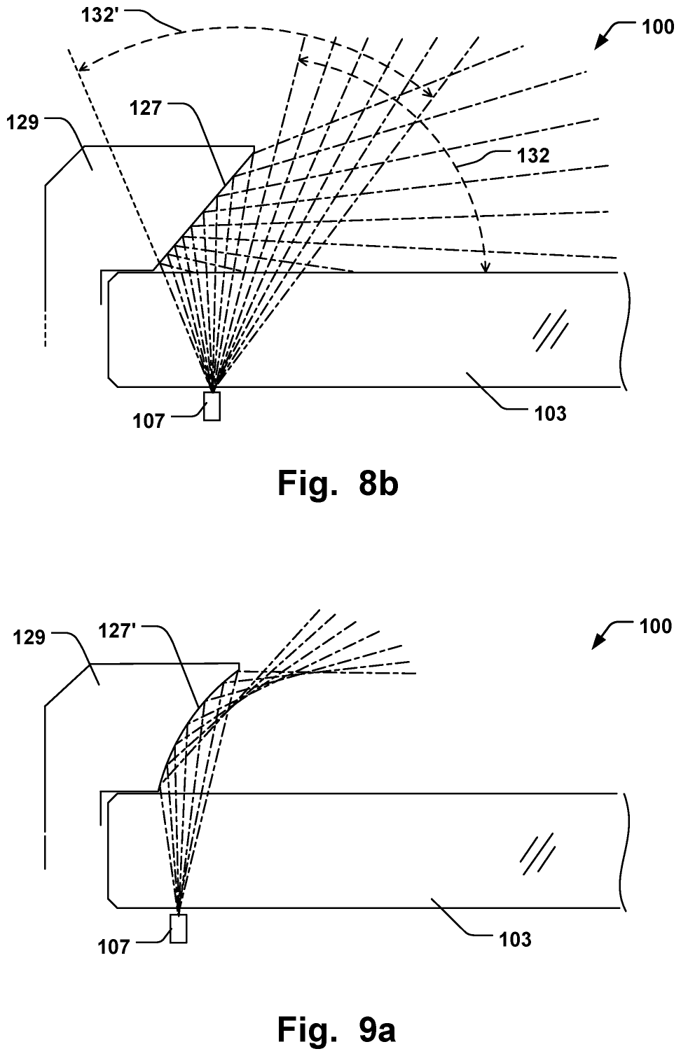

The sensor 107 may in some examples be arranged at least partly below the panel 103 in the direction of the normal axis 106. FIGS. 5a-b, 6, 7a-b, 8a-b, 9a-b, 22, are schematic illustrations of the sensor 107 arranged below the panel 103. The sensor 107 receives the incident light 108 from the object 110 through the panel 103 in the aforementioned examples. It should be understood however that the sensor 107 may be arranged below the panel 103 while the incident light 108 is reflected around panel edges 115, e.g., via a prism 130. The panel edge 115 extends between the surface 102 and a rear side 117 being opposite the surface 102. Having the sensor 107 arranged below the panel 103 in the direction of the normal axis 106, such as in FIGS. 8a-b and 9a-b, provides for a compact profile of the frame element 129 in the direction of the plane 105.

The sensor 107 may be angled from the normal 106 to optimize the field of view towards the object 110, as schematically illustrated in e.g., FIGS. 7a-b. The sensor 107 may be angled 60 degrees with respect to the normal axis 106 in one example.

The panel 103 may have a panel edge 115 extending between the surface 102 and a rear side 117 being opposite the surface 102. The panel edge 115 may comprise a chamfered surface 116, as schematically illustrated in FIGS. 7b-c. The chamfered surface 116 is angled with respect to the normal axis 106 with an angle 125. Incident light 108 from the object 110, propagating through the panel 103, is coupled to the sensor 107 via the chamfered surface 116. The angle 125 may be chosen so that a surface normal of the chamfered surface 116 is parallel with an optical axis of the sensor 107. This provides in some examples for reducing unwanted reflections as the light is coupled to the sensor 107. FIG. 7c shows an example where the height (h_{c}) of chamfer corresponds essentially to the thickness of the panel 103 along the normal axis 106, apart from a rounded tip close to the surface 102. This provides for an efficient coupling of light to the sensor 107 when the optical axis of the sensor 107 is tilted with an increased angle relative the normal axis 106.

The sensor 107 may in some examples be mounted in alignment with the chamfered surface 116, for coupling of light propagating though the panel 103, or for a facilitated alignment of the sensor 107 to obtain a desired field of view 132 when the sensor 107 is positioned to receive incident light 108 from above the surface 102 (FIG. 16). The sensor 107 may be mounted to a sensor support 118, as exemplified in FIG. 16. The sensor support 118 may have a corresponding mating surface 142 for engagement with the chamfered surface 116, i.e., by having the same alignment with respect to the normal axis 106, for a facilitated mounting of the sensor 107 at a desired angle. The sensor support 118 may be aligned with the chamfered surface 116 while the sensor 107 is arranged at least partly above the surface 102, as exemplified in FIG. 16.

In one example the sensor 107 may be mounted directly to the chamfered surface 116, e.g., with an adhesive, when coupling light from the panel 103. In one example the sensor support 118 is mounted to the chamfered surface 116, e.g., with an adhesive, while the sensor 107 is arranged at least partly above the surface 102 (FIG. 16).

The sensor support 118 may in some examples comprise a sensor substrate 143, as illustrated in FIG. 18. The sensor substrate 143 may be mounted to the frame element 129 with an angle to obtain the desired field of view 132 above the surface 102. The sensor substrate 143 may be different from the substrate 119 to which the emitters 137 and detectors 138 are mounted (see e.g., FIG. 16). Alternatively, the sensor substrate 143 may be integrated with, or connected to, the substrate 119 for the emitters 137 and detectors 138, as exemplified in FIG. 20.

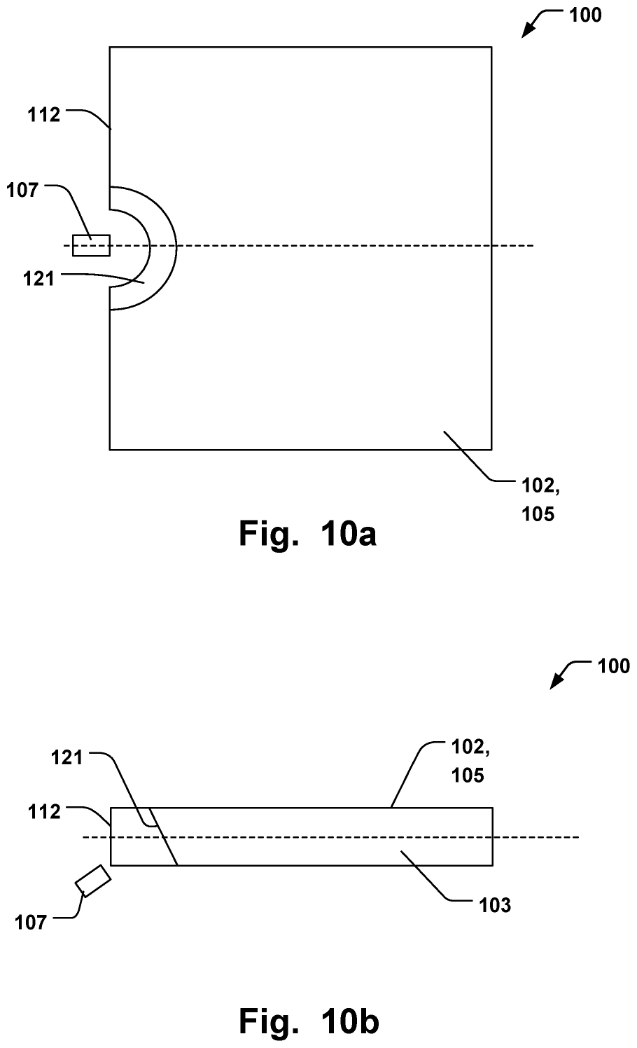

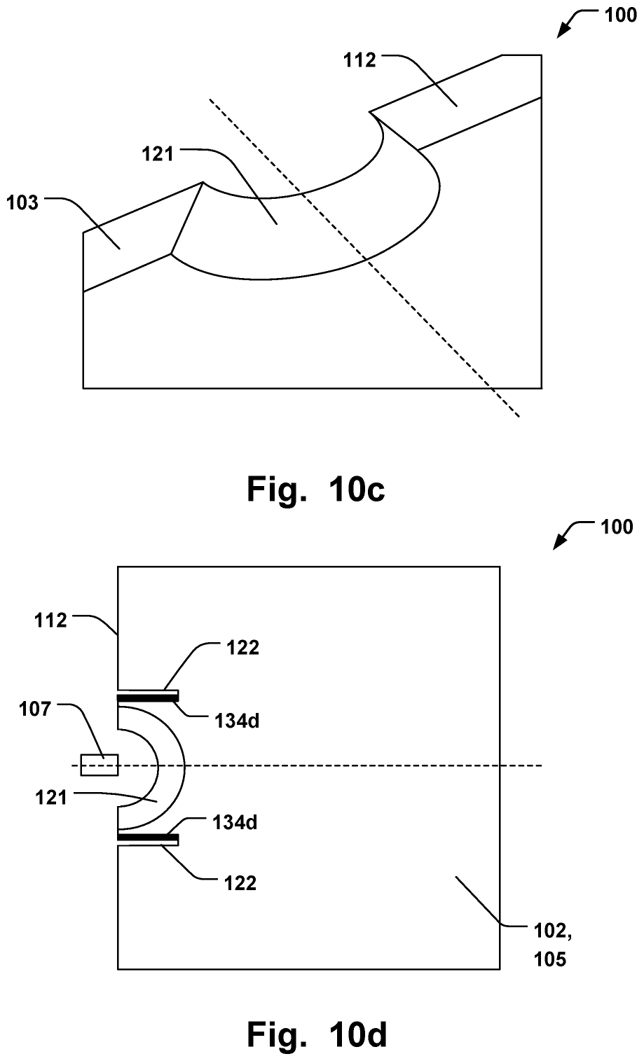

The chamfered surface 116 may be arranged in a semi-circular cut-out 121 in the panel side 112, as illustrated in FIGS. 10a-d. FIG. 10a is a top-down view illustrating the semi-circular cut-out 121, and FIG. 10b is a cross-sectional side view. This provides for an advantageous coupling of light from the panel 103 to the sensor 107 in some applications with a reduced amount of ambient stray light. FIG. 10c is a perspective view of the semi-circular cut-out 121 which can be seen as a partial cone-shaped surface. The panel 103 may have cut-outs 122 at either side of the semi-circular cut-out 121, as schematically illustrated in FIG. 10d. A light absorbing surface 134d may be arranged in the respective cut-out 122 to prevent unwanted straylight reflections from the sides reaching the semi-circular cut-out 121 (i.e., in the vertical direction in FIG. 10d).

The interaction system 100 may comprise a mounting prism 123 arranged below the surface 102 to couple incident light 108 from the object 110, propagating through the panel 103, to the sensor 107 at an angle 126 from the normal axis 106. FIG. 7a is a schematic illustration of a mounting prism 123 arranged at the rear side 117, and a sensor 107 aligned with the mounting prism 123. The mounting prism 123 provides for coupling of light to the sensor 107 with a reduced amount of unwanted reflections, as described with respect to the chamfered surface 116 above. The mounting prism 123 provides also for a facilitated mechanical mounting and alignment of the sensor 107 relative the panel 103.

The interaction system 100 may comprise a reflecting surface 127 extending at least partly above the surface 102 in the direction of the normal axis 106. The reflecting surface 127 may be arranged to reflect incident light 108 from the object 110 towards the sensor 107, as schematically illustrated in e.g., FIGS. 8a-b, 9a-b, 11b-c. The reflecting surface 127 provides for optimizing the field of view 132 of the sensor 107 above the surface 102, while the sensor 107 may be arranged to maintain a compact profile of the frame element 129 around the panel 103, e.g., by having the sensor 107 arranged below the surface 102 or the panel 103, as exemplified in FIG. 8a. Hence, the reflecting surface 127 may be angled with an angle 131 from the normal axis 106 to so that an optical path between the sensor 107 and the object 110 has a defined field of view 132 above the surface 102. FIG. 8b shows another example where the reflecting surface 127 is aligned to overlap part of the field of view 132′ seen as the virtual non-reflected extension of the sensor's image circle around its optical axis. The effective reflected field of view 132 may be increased in this case since only part of the image is reflected by reflecting surface 127.

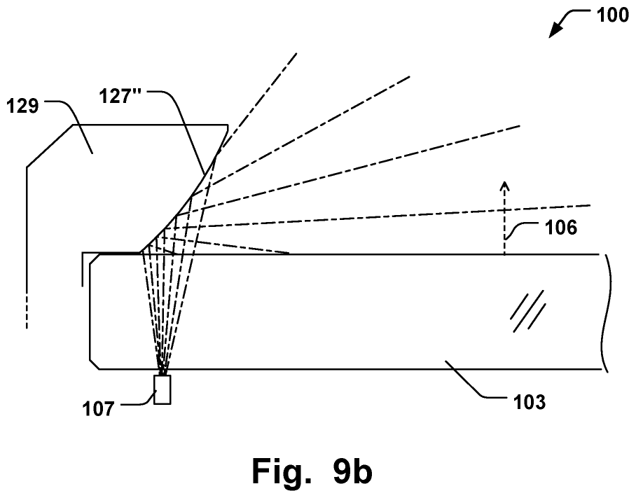

The reflecting surface 127 may comprise a concave reflecting surface 127′, as exemplified in FIG. 9a. The reflecting surface 127 may comprise a convex reflecting surface 127″, as exemplified in FIG. 9b. This may provide for increasing the field of view angle along the normal axis 106, which may be desirable in some applications. The concave or convex reflecting surface 127′, 127″, may be cylindrically or spherically concave or convex, respectively.

The reflecting surface 127, 127′, 127″, may be arranged on a frame element 129 of the interaction system 100, as exemplified in FIGS. 8a-b, 9a-b. This provides for maintaining a compact profile around the panel 103. The reflecting surface 127 may be provided by a prism 130, as exemplified in FIGS. 11b-c, in which the incident light 108 is internally reflected towards the sensor 107. The interaction system 100 may thus comprise a prism 130 arranged at the perimeter 104.

The prism 130 may comprise a refractive surface 144a, 144b, extending at least partly above the surface 102 of the panel 103 in the direction of the normal axis 106. The refracting surface 144a, 144b, thus being arranged to refract incident light 108 from the object 110 towards the sensor 107. FIG. 11a shows an example where the sensor 107 is arranged below, or at least partly below, the surface 102. The incident light 108 is in this case refracted at first and second refractive surfaces 144a, 144b, towards the sensor 107. The prism 130 directs the incident light 108 so that the field of view is shifted above the surface 102. A virtual aperture of the sensor 107 is provided above the surface 102. FIGS. 11b-c show the incident light 108 being refracted at first refractive surface 144a before being reflected at the internal reflective surface 127 towards the sensor 107. The triangular prism 130 in FIG. 11b provides a field of view 132 extending down to the surface 102. Hence, the reflecting surface 127 may be angled with an angle 131 from the normal axis 106 to so that an optical path between the sensor 107 and the object 110 has a defined field of view 132 above the surface 102.

The position of the sensor 107 is shifted relative to the prism 130 in FIG. 11c so that the field of view is moved upwards along the normal axis 106.

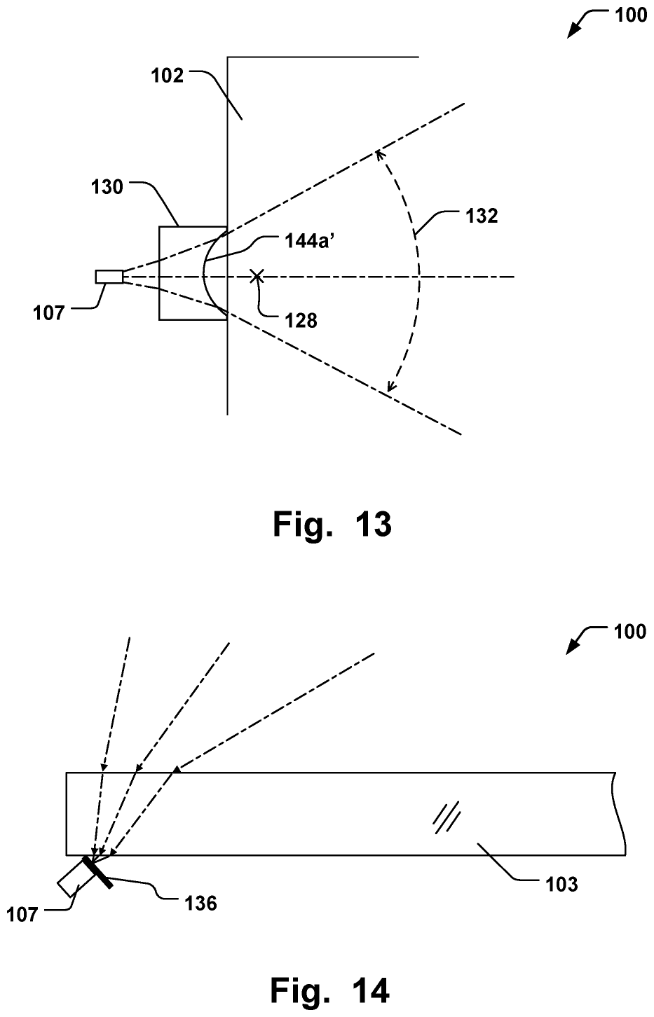

The refracting surface 144a, 144b, may comprise a concave or convex refracting surface. Such concave or convex reflecting surface may be cylindrically or spherically concave or convex, respectively. FIG. 13 shows an example where the first refracting surface 144a of a prism 130 comprises a concave refracting surface 144a′. The concave refracting surface 144a′ has in this example a radius of curvature with respect to an axis 128 extending in parallel with the normal axis 106. This provides for increasing the field of view 132 in the plane 105 of the surface 102.

The sensor 107 may in some examples comprise a lens to optimize field of view angle 132 to different applications.

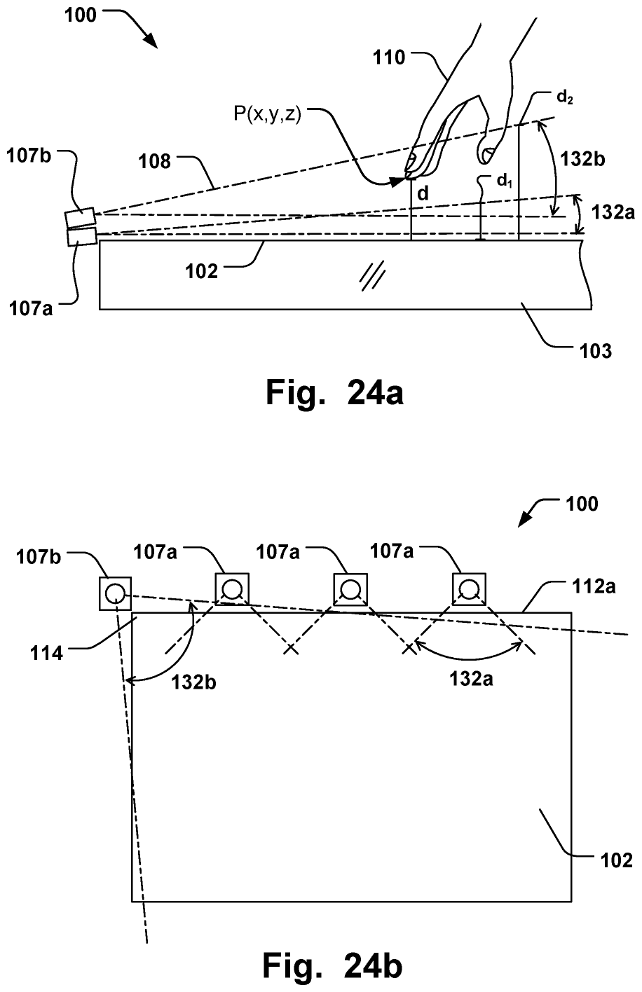

The interaction system 100 may comprise a first sensor 107a having a first field of view 132a and a second sensor having a second field of view 132b. The first and second sensors 107a, 107b, may be combined to provide an optimized sensor coverage over the surface 102. For example, the first sensor 107a may be arranged so that the first field of view 132a covers a first distance d₁ above the surface 102. The first sensor 107a may thus effectively cover a first sensor volume, which extends between a position closest to the surface 102 and the first distance d₁, while the second sensor 107b covers a second sensor volume extending further above the first sensor volume to a second distance d₂ above the surface 102, as schematically indicated in FIG. 24a. The first and second sensor volumes may overlap for an improved coverage. The first sensor volume may be smaller than the second sensor volume. The first sensor 107a may be configured to detect objects 110 with a greater resolution than the second sensor 107b. Each of the first and second sensor volumes may cover the area of the surface 102 along the x-y corrdinates.

The first and second sensors 107a, 107b, may be arranged at different positions along the sides of the panel 103. A plurality of first and second sensors 107a, 107b, may be arranged along the sides of the panel 103. FIG. 24b is a top-down view of the surface 102. A plurality of first sensors 107a, each having a respective first field of view 132a covering a respective first sensor volume, may be arranged along a side 112a of the panel 103. A second sensor 107b may be arranged at a corner 114 of the panel 103. The second sensor 107b has a second field of view 132b and an associated second sensor volume extending over the surface 102.

Combining sensor volumes of different sizes and resolution provides for an optimized object detection. E.g. an approaching object 110 may be detected by the second sensor 107b to prepare or set up the interaction system 100 for a certain user interaction, such as displaying a particular control element in a GUI controlled by the interaction system 100. Thus, a user may be presented with such GUI control element when approaching the panel 103 from a distance and reaching the second sensor volume. Once the user has moved closer and approached the panel 103, and subsequently extends an object 110 into the first sensor volume of the first sensor 107a, the user may access a second set of controls in the GUI, as the first sensor 107a detects object 110. An increased resolving power of the first sensor 107a provides for an increased degree of precision in manipulating the second set of controls, such as accessing and controlling individual subsets of elements of the previously presented GUI control element. As the user touch the surface 102 with the object 110 a further, third layer of control input may be accessed. I.e. for touch input in the interaction system 100, e.g. executing a particular function accessed by the previously presented control element and subsets of control elements.

The interaction system 100 may be configured to receive control input from several of such input layers simultaneously. For example, a displayed object may be selected by touch input, e.g. by the user's left hand, while the right hand may be used to access a set of controls, by gesture input to sensor 107 as described above, to manipulate the currently selected object in the GUI via gestures.

The interaction system 100 may be configured to detect the transition between the different input layers, such as the change of state of an object 110 going from gesturing or hovering above the surface 102 to contacting the surface 102, and vice versa. Detecting such transition provides e.g. for calibrating the position of the object 110 in the x-y coordinates for gesturing above the panel 103, as the position currently determined by sensor 107 can be correlated with the detected touch input at the current x-y coordinate.

A light source 111, 111a, 111b, for illuminating the object 110, referred to as illuminator 111, 111a, 111b, is described by various examples below.

The interaction system 100 may comprise at least one illuminator 111, 111a, 111b, configured to emit illumination light 120 towards the object 110. The object 110 scatters at least part of the illumination light 120 towards the sensor 107, as schematically illustrated in FIGS. 3a-b. The interaction system 100 may comprise any plurality of illuminators 111, 111a, 111b, as exemplified in FIGS. 3a-b, 4a-c, 15, 17, 19. In one example the interaction system 100 comprises a single illuminator 111 (e.g., FIG. 3a). The illuminator 111 or illuminators 111a, 111b, are referred to as illuminator 111 in examples below for brevity. The panel 103 may be designed to be overlaid on or integrated into a display device 301. Light emitted by the display device 301 may in such case be utilized as illumination light 120.

The illuminator 111 may emit visible light and/or IR light. The illuminator 111 may comprise a plurality of LED's arranged around the perimeter 104 of the panel 103. The illuminator 111 may be configured to emit a wide continuous illumination light 120 across the surface 102. The illumination light 120 may be pulsed light. The illuminator 111 may comprise a laser. The sensor 107 may comprise an integrated illuminator 111, e.g., laser, when comprising a TOF camera, such as a LIDAR. The sensor 107 may comprise a scanning LIDAR, where a collimated laser scans the surface 102. The sensor 107 may comprise a flash LIDAR where the entire field of view is illuminated with a wide diverging laser beam in a single pulse. The TOF camera may also be based on LED illumination, e.g., pulsed LED light.

The illuminator 111 may be arranged between the sensors 107a, 107b, along the perimeter 104, as exemplified in FIG. 3a. The illuminator 111 may comprise a plurality of illuminators 111a, 111b arranged along opposite sides 112a, 112b of the panel 103, as exemplified in FIGS. 4a-b. This may facilitate illuminating the interaction space across the panel 103, with less brightness required for the individual illuminators 111a, 111b. The illuminators 111a, 111b, may thus be operated with less power.

Sensors 107a, 107b, may be arranged along a third side 112c extending perpendicular to, and connecting, the opposite sides 112a, 112b, where the illuminators 111a, 111b, are arranged, as exemplified in FIGS. 4a-b.

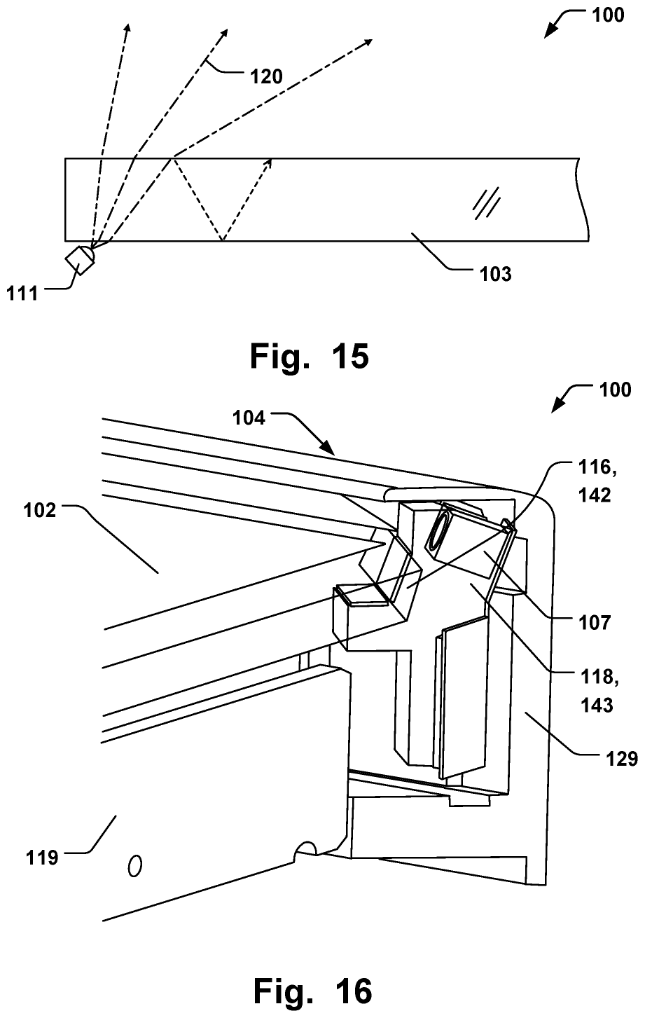

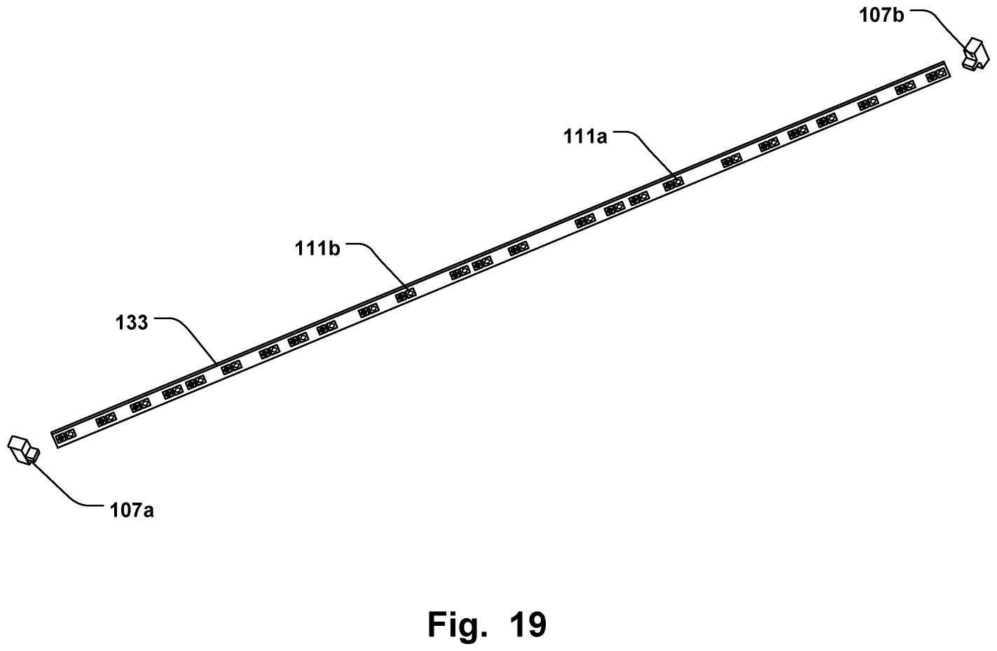

The illuminator 111 may be arranged to emit illumination light 120 towards the object 110 through the panel 103, as exemplified in FIG. 15. The illuminator 111 may thus be mounted below the panel 103. The illuminator 111 may be mounted to a substrate, such as the substrate 119 onto which the emitters 137 and detectors 138 are mounted. Alternatively, the illuminator 111 may be mounted to a separate illuminator support 133. FIG. 17 shows a cross-sectional side view, where it should be understood that illuminator 111 may be mounted to any of the aforementioned substrates 119, 133, which in turn are mounted into the frame element 129. FIG. 19 shows an example of an elongated illuminator support 133 to be arranged along the perimeter 104. A plurality of illuminators 111a, 111b, may be mounted to the support 133. The support 133 with illuminators 111a, 111b, and sensors 107a, 107b, may be provided as a hardware kit to upgrade different touch-sensing apparatuses. The sensors 107a, 107b, may be integrated with the support 133 in some examples. It is conceivable that in one example emitters 137 and detectors 138 are also mounted to the support 133.

The illumination light 120 may be directed to the interaction space above the surface 102 via a light directing arrangement 139, as illustrated in the example of FIG. 17. Further, any reflecting surface 127 and/or refractive surface 144a, 144b, as described above with respect to the sensor 107 may be utilized to direct the illumination light 120 above the surface 102, e.g., via a reflecting surface 127 on a frame element 129 or in a prism 130, and/or a refractive surface 144a, 144b, of a prism 123, 130. In a further example a chamfered surface 116 of the panel 103 may reflect the illumination light 120 above the surface 102. In another example, the illuminator 111 is arranged above, or at least partly above, the surface 102 to emit illumination light 120 towards the object 110, as indicated in FIG. 3b.

The illuminator 111 may be arranged at corresponding positions as described above for the sensor 107. I.e., in FIGS. 1-20 described above, the sensor 107 may be replaced with the illuminator 111, in further examples of the interaction system 100.

The illuminator 111 may comprise a lens to optimize the direction of the illumination light 120 across the panel 103.

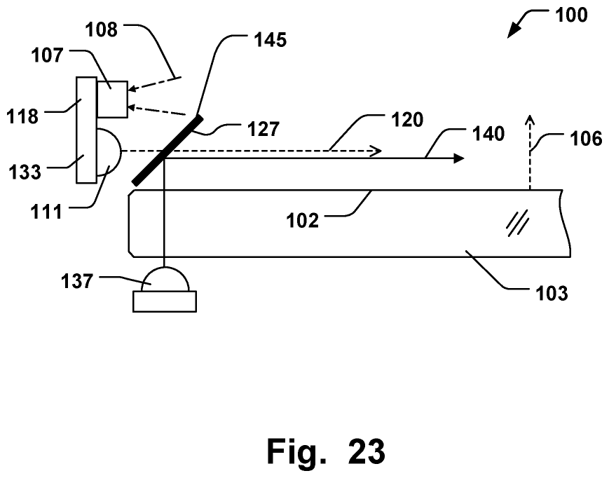

The interaction system 100 may comprise a reflecting element 145 which is configured to reflect light 140 from emitters 137 to the surface 102 as well as transmit illumination light 120 from an illuminator 111, as exemplified in FIG. 23. The reflecting element 145 may comprise a semi-transparent mirror 145. The reflecting element 145, such as the semi-transparent mirror 145, may have a multilayer coating reflecting the wavelength of the light 140 from the emitters 137 while transmitting the wavelength of the illumination light 120. The illuminator 111 may be arranged above, or at least partly above, the touch surface 102 as exemplified in FIG. 23. The illuminator 111 may be arranged behind the reflecting element 145, such that the reflecting element 145 is positioned between the touch surface 102 and illuminator 111, as further exemplified in FIG. 23.

The sensor 107 may be arranged above, or at least partly above, the touch surface 102 as schematically illustrated in FIG. 23, to receive incident light 108 from the object 110. The illuminator support 133 and the sensor support 118 may in one example be integrated as a single support as schematically illustrated in FIG. 23, or may be separate supports.

In another example the illuminator is arranged below the touch surface 102 or below the panel 103, with respect to the vertical direction of the normal axis 106, while the illumination light 120 is directed through the reflecting element 145, as in FIG. 23, via further reflecting surfaces (not shown).

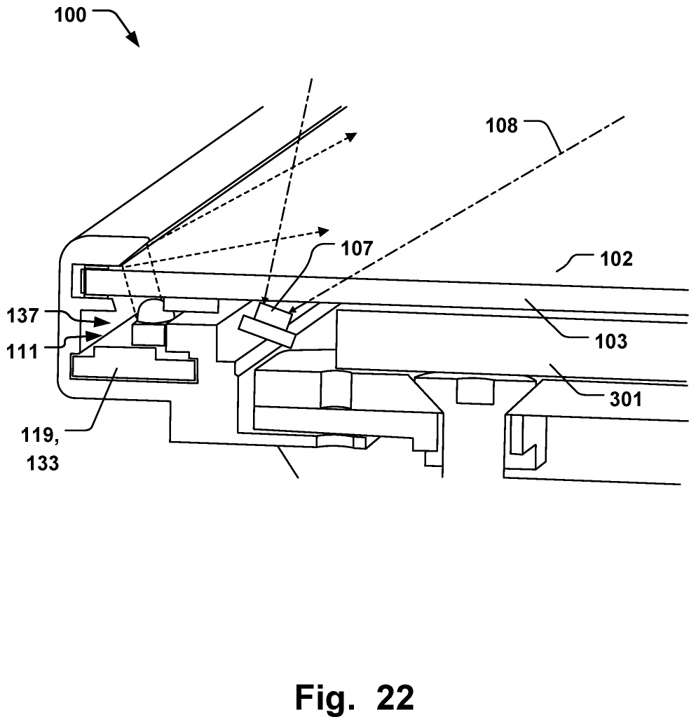

FIG. 22 shows a further schematic illustration of the interaction system 100, where the sensor 107, emitters 137, and illuminator 111 are arranged below the panel 103. The sensor 107 receives the incident light 108 from the object 110 through the panel 103. The emitters 137 and the illuminator 111 emit light through the panel 103. This provides for a particularly narrow bezel around the panel 103.

The illumination light 120 may be reflected towards the object 110 by diffusive or specular reflection. The illuminator 111 may comprise a light source coupled to an elongated diffusively scattering element extending along a side 112a, 112b, 112c, of the panel 103 to distribute the light across the panel 103. The diffusively scattering element may be milled or otherwise machined to form a pattern in a surface of the frame element 129, such as an undulating pattern or grating. Different patterns may be formed directly in the frame element 129 by milling or other machining processes, to provide a light directing surface with desired reflective characteristics to control the direction of the light across the surface 102. The diffusive light scattering surface may be provided as an anodized metal surface of the frame element 129, and/or an etched metal surface, sand blasted metal surface, bead blasted metal surface, or brushed metal surface of the frame element 129.

Further examples of the diffusive light scattering elements having a diffusive light scattering surface are described in the following. The diffusive light scattering surface may be configured to exhibit at least 50% diffuse reflection, and preferably at least 70-85% diffuse reflection. Reflectivity at 940 nm above 70% may be achieved for materials with e.g., black appearance, by anodization as mentioned above (electrolytic coloring using metal salts, for example). A diffusive light scattering surface may be implemented as a coating, layer or film applied by e.g., by anodization, painting, spraying, lamination, gluing, etc. Etching and blasting as mentioned above is an effective procedure for reaching the desired diffusive reflectivity. In one example, the diffusive light scattering surface is implemented as matte white paint or ink. In order to achieve a high diffuse reflectivity, it may be preferable for the paint/ink to contain pigments with high refractive index. One such pigment is TiO2, which has a refractive index n=2.8. The diffusive light scattering surface may comprise a material of varying refractive index. It may also be desirable, e.g., to reduce Fresnel losses, for the refractive index of the paint filler and/or the paint vehicle to match the refractive index of the material on which surface it is applied. The properties of the paint may be further improved by use of EVOQUE™ Pre-Composite Polymer Technology provided by the Dow Chemical Company. There are many other coating materials for use as a diffuser that are commercially available, e.g., the fluoropolymer Spectralon, polyurethane enamel, barium-sulphate-based paints or solutions, granular PTFE, microporous polyester, GORE® Diffuse Reflector Product, Makrofol® polycarbonate films provided by the company Bayer AG, etc. Alternatively, the diffusive light scattering surface may be implemented as a flat or sheet-like device, e.g., the above-mentioned engineered diffuser, diffuser film, or white paper which is attached by e.g., an adhesive. According to other alternatives, the diffusive light scattering surface may be implemented as a semi-randomized (non-periodic) micro-structure on an external surface possibly in combination with an overlying coating of reflective material. A micro-structure may be provided on such external surface and/or an internal surface by etching, embossing, molding, abrasive blasting, scratching, brushing etc. The diffusive light scattering surface may comprise pockets of air along such internal surface that may be formed during a molding procedure. In another alternative, the diffusive light scattering surface may be light transmissive (e.g., a light transmissive diffusing material or a light transmissive engineered diffuser) and covered with a coating of reflective material at an exterior surface. Another example of a diffusive light scattering surface is a reflective coating provided on a rough surface.

The diffusive light scattering surface may comprise lenticular lenses or diffraction grating structures. Lenticular lens structures may be incorporated into a film. The diffusive light scattering surface may comprise various periodical structures, such as sinusoidal corrugations provided onto internal surfaces and/or external surfaces. The period length may be in the range of between 0.1 mm-1 mm. The periodical structure can be aligned to achieve scattering in the desired direction.

Hence, as described, the diffusive light scattering surface may comprise; white- or colored paint, white- or colored paper, Spectralon, a light transmissive diffusing material covered by a reflective material, diffusive polymer or metal, an engineered diffuser, a reflective semi-random micro-structure, in-molded air pockets or film of diffusive material, different engineered films including e.g., lenticular lenses, or other micro lens structures or grating structures. The diffusive light scattering surface preferably has low NIR absorption.

In a variation of any of the above embodiments wherein the diffusive light scattering element provides a reflector surface, the diffusive light scattering element may be provided with no or insignificant specular component. This may be achieved by using either a matte diffuser film in air, an internal reflective bulk diffusor, or a bulk transmissive diffusor.

The interaction system 100 may comprise a pattern generator (not shown) in the optical path of illumination light 120, propagating from the illuminator 111 towards the object 110, to project onto the object 110 a coherent pattern. The sensor 107 may be configured to detect image data of the pattern on the object 110 to determine the position (P) of the object 110 based on a shift of the pattern in the image data relative a reference image of said pattern.

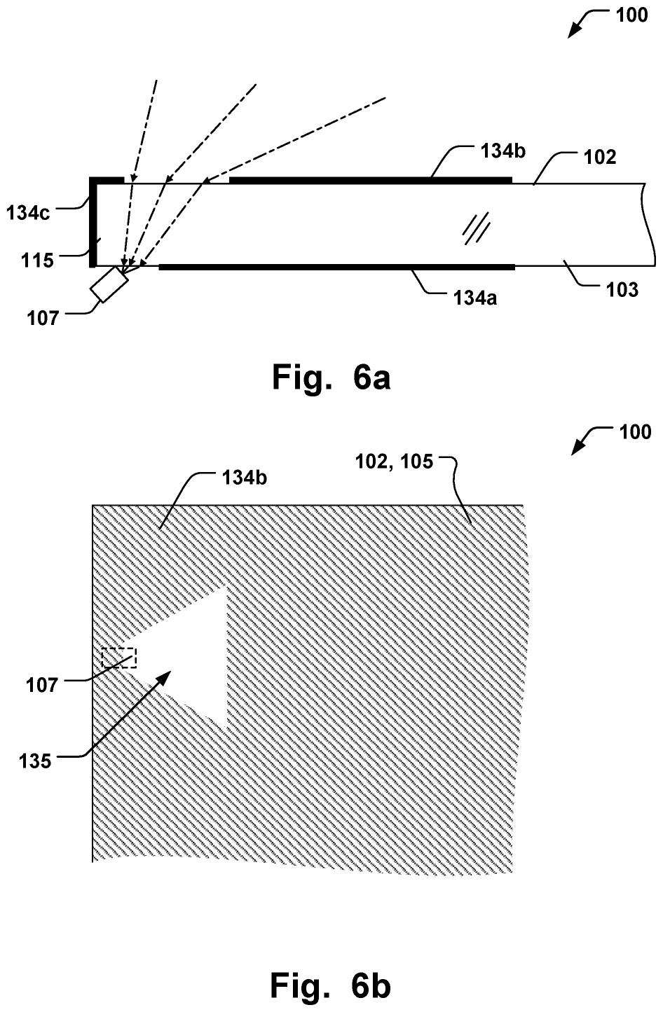

The interaction system 100 may comprise a light absorbing surface 134a, 134b, 134c, 134d, arranged on the panel 103 adjacent the sensor 107. FIG. 10d, as described above, illustrates one example of having such light absorbing surface 134d. FIG. 5b shows an example where a light absorbing surface 134a is arranged on the rear surface 117 of the panel 103 to reduce stray light 141 propagating inside the panel 103. FIGS. 6a-b show further examples where a plurality of light absorbing surfaces 134a, 134b, 134c, are provided around the panel 103 adjacent the sensor 107. Thus, a light absorbing surface 134b may be arranged on the surface 102, and/or a light absorbing surface 134c may be arranged along edges 115 of the panel 103, and/or a light absorbing surface 134a may be arranged on the rear side 117 of the panel 103. The light absorbing surface 134a, 134b, 134c, may comprise an aperture 135 through which the incident light 108 propagates from the object 110 to the sensor 107, as schematically illustrated in the top-down view of FIG. 6b. This provides further for minimizing the impact of stray light in the detection process. The aperture 135 may have different shapes, such as rectangular, triangular, circular, semi-circular, or rhombus, to be optimized to the position of the sensor 107 and the particular application.

Optical filters 136 may also be arranged in the optical path between the object 110 and the sensor 107, as schematically indicated in FIG. 14. The filter 136 may comprise a polarizing filter to reduce reflections in desired directions, and/or wavelength selective filters.

The interaction system 100 may comprise a touch sensing apparatus 101. The touch sensing apparatus 101 provides for touch input on the surface 102 by the object 110. The surface 102 may thus be utilized as a touch surface 102. As described in the introductory part, in one example the touch sensing apparatus 101 may comprise a plurality of emitters 137 and detectors 138 arranged along the perimeter 104 of the panel 103. A light directing arrangement 139 may be arranged adjacent the perimeter 104. The emitters 137 may be are arranged to emit a respective beam of emitted light 140 and the light directing arrangement 139 may be arranged to direct at least part of the emitted light 140 across the surface 102 to the detectors 138, as schematically illustrated in FIGS. 2a-b. The plurality of emitters 137 may thus be arranged to emit light across the panel 103, to provide touch detection light of the touch sensing apparatus 101 that propagates across the surface 102. Detectors 138 may be arranged at adjacent or opposite sides of the panel 103 to receive the detection light so that a grid of scanlines is obtained for touch detection.

In one example, the emitters 137 may be utilized as illuminators 111 to emit illumination light 120 towards the object 110. Further, the detectors 138 may be utilized as sensors 107 receiving scattered light from the object 110. The detectors 138 may be used in conjunction with the above-described sensors 107 to determine the position (P) of the object 110 with a further increased accuracy and responsiveness of the user's different inputs. A light directing arrangement 139 to direct light from emitters 137 to the surface 102 may be utilized as a light reflecting surface 127 for the sensor 107 and/or the illuminator 111, or vice versa. This may provide for a compact and less complex manufacturing of the interaction system 100 since the number of opto-mechanical components may be minimized.

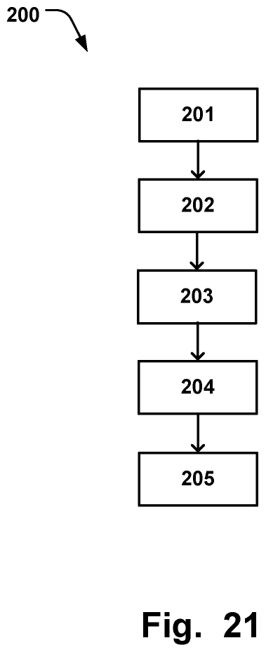

FIG. 21 is a flow-chart of a method 200 for receiving gesture input from an object 110 in an interaction system 100 comprising a panel 103. The method 200 comprises detecting 201 incident light 108 from the object 110, determining 202 a position (P) of the object 110 relative a surface 102 of the panel 103 based on the incident light 108, when the object 110 is at a distance (d) from the surface 102 along a normal axis 106 of the surface 102. The method 200 comprises determining 203 the gesture input based on said position (P), and outputting 204 a control signal to control 205 the interaction system 100 based on the gesture input. The method 200 thus provides for the advantageous benefits as described above for the interaction system 100 in relation to FIGS. 1-20. The method 200 provides for a facilitated and intuitive user interaction while providing for an increased level of control, precision, and efficient workflow, such as in complex GUI's.

A computer program product is provided comprising instructions which, when the program is executed by a computer, cause the computer to carry out the steps of the method 200 as described in relation to FIG. 21.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

1. An interaction system for receiving gesture input from an object comprising:
a panel having a surface and a perimeter, the surface extending in a plane having a normal axis,
a sensor configured to detect incident light from the object,
a processor in communication with the sensor and being configured to;
determine a position of the object relative the surface based on the incident light, when the object is at a distance from the surface along the normal axis,
determine the gesture input based on said position, and
output a control signal to control the interaction system based on the gesture input.

2. The interaction system according to claim 1, wherein the sensor comprises a plurality of sensors arranged along said perimeter.

3. The interaction system according to claim 2, wherein the sensors are arranged at corners of the panel.

4. The interaction system according to claim 2, wherein the sensors are arranged at opposite sides of the panel.

5. The interaction system according to claim 1, wherein the sensor comprises an IR camera, and/or a visible light camera, and/or a time-of-flight camera, and/or a thermal camera.

6. The interaction system according to claim 1, wherein the sensor is arranged partly below the surface in a direction of the normal axis.

7. The interaction system according to claim 1, wherein the sensor is arranged below the panel in a direction of the normal axis.

8. The interaction system according to claim 6, wherein the panel has a panel edge extending between the surface and a rear side being opposite said surface, wherein the panel edge comprises a chamfered surface, and the sensor is arranged to receive incident light from the chamfered surface.

9. The interaction system according to claim 8, wherein the chamfered surface is arranged in a semi-circular cut-out in the panel side.

10. The interaction system according to claim 1, comprising a mounting prism arranged below the surface of the panel to couple incident light from the object, propagating through the panel, to the sensor at an angle from the normal axis.

11. The interaction system according to claim 1, further comprising a reflecting surface extending at least partly above the surface of the panel in the direction of the normal axis, the reflecting surface being arranged to reflect incident light from the object towards the sensor.

12. The interaction system according to claim 11, wherein the reflecting surface comprises a concave reflecting surface or convex reflecting surface.

13. The interaction system according to claim 11, wherein the reflecting surface is arranged on a frame element of the touch sensing apparatus.

14. The interaction system according to claim 11, wherein the reflecting surface is angled with an angle from the normal axis to so that an optical path between the sensor and the object has a defined field of view above the surface of the panel.

15. The interaction system according to claim 1, further comprising a prism arranged at the perimeter, the prism comprises a refractive surface extending at least partly above the surface of the panel in the direction of the normal axis, the refracting surface being arranged to refract incident light from the object towards the sensor.

16. The interaction system according to claim 15, wherein the refractive surface comprises a concave refracting surface, wherein the concave reflecting surface has a radius of curvature with respect to an axis extending in parallel with the normal axis.

17. The interaction system according to claim 1, further comprising at least one illuminator configured to emit illumination light (120) towards the object, whereby the object scatters the illumination light towards the sensor.

18. The interaction system according to claim 2, wherein the illuminator is arranged between the sensors along the perimeter.

19. The interaction system according to claim 17, wherein the illuminator comprises a plurality of illuminators arranged along opposite sides of the panel.

20. The interaction system according to claim 17, wherein the illuminator is arranged to emit illumination light towards the object through the panel.

21. The interaction system according to claim 17, comprising a pattern generator in the optical path of illumination light propagating from the illuminator towards the object to project onto the object a coherent pattern, wherein the sensor is configured to detect image data of the pattern on the object to determine said position based on a shift of the pattern in the image data relative a reference image of said pattern.

22. The interaction system according to claim 1, further comprising a light absorbing surface arranged on the panel adjacent the sensor.

23. The interaction system according to claim 1, wherein the light absorbing surface comprises an aperture through which the incident light propagates from the object to the sensor.

24. The interaction system according to claim 1, further comprising:
a touch-sensing apparatus configured to receive touch input on the surface of the panel, wherein the touch-sensing apparatus comprises
a plurality of emitters and detectors arranged along the perimeter of the panel,
a light directing arrangement arranged adjacent the perimeter, wherein the emitters are arranged to emit a respective beam of emitted light and the light directing arrangement is arranged to direct the emitted light across the surface of the panel to the detectors.

25. A method for receiving gesture input from an object in an interaction system comprising a panel, the method comprising:
detecting incident light from the object,
determining a position of the object relative a surface of the panel based on the incident light, when the object is at a distance from the surface along a normal axis of the surface,
determining the gesture input based on said position, and
outputting a control signal to control the interaction system based on the gesture input.

26. A computer program product comprising instructions which, when the program is executed by a computer, cause the computer to carry out the steps of the method according to claim 25.
